(19) United States
(12) Patent Application Publication
(10) Pub. No.: US 2016/0239838 A1
(43) Pub. Date: Aug. 18, 2016

(54) INFORMATION PROCESSING SYSTEMS, APPARATUSES, AND METHODS

(71) Applicant: LINE Corporation, Tokyo (JP)

(72) Inventors: Heechan YANG, Tokyo (JP); Kenichi SUGIMOTO, Tokyo (JP); Tomohiko TANIGUCHI, Tokyo (JP)

(21) Appl. No.: 14/830,451

(22) Filed: Aug. 19, 2015

(30) Foreign Application Priority Data
Feb. 16, 2015 (JP) 2015-027316

(51) Int. Cl. G06Q 20/40; G06Q 20/38; G06Q 20/34

(52) U.S. Cl. CPC G06Q 20/40; G06Q 20/34; G06Q 20/382

(57) ABSTRACT

An information processing system including one or more information processing apparatus, includes a first credit inquiry unit performing a credit inquiry on a credit card to be used for a transaction related to a desired commercial transaction when a request, which requests an approval of paying for the desired commercial transaction, is transmitted to a terminal apparatus and a response to the request is received from the terminal apparatus; and a payment instruction unit, in a case where the response to the request includes separate checks information, which indicates the payment is to be made by a plurality of users, and content of the desired commercial transaction has been changed within a desired time period since performing the credit inquiry, instructing payment of the changed commercial transaction.

### CROSS-REFERENCE TO RELATED APPLICATIONS

This U.S. non-provisional application claims the benefit of priority under 35 U.S.C §119 to Japanese Patent Application No. 2015-027316 filed on Feb. 16, 2015, in the Japanese Patent Office (JPO), the disclosure of which is incorporated herein in its entirety by reference.

### BACKGROUND

1. Field

The example embodiments generally relate to an information processing system and/or an information processing method.

2. Description of the Related Art

Conventionally, there has been a known technique for paying by credit card using a terminal such as a cellular phone, etc. Further, a payment is often made by so-called “separate checks” (i.e., splitting a check, bill split, split the bill equally, each paying for his/her own account, sharing the expenses, etc.) when, for example, several persons have a meal or buy something together.

In this regard, there is a known technique in which after a representative user pays (a full amount) by his/her credit card, the payment processes are made by separate checks with the other user(s). By using such a technique, it becomes possible to pay by separate checks by two or more users.

### SUMMARY

According to an aspect of the inventive concepts according to at least one example embodiment, an information processing system including one or more information processing apparatuses, may include a memory having computer readable instructions stored thereon, and at least one processor configured to execute the computer readable instructions to, transmit a first request to a first terminal apparatus, the first request including a request for payment of a desired commercial transaction, receive a response to the first request from the first terminal apparatus, the response including an approval of paying for the desired commercial transaction, perform a credit inquiry on a credit card to be used for a transaction related to the desired commercial transaction, determine whether the response includes separate checks information, the separate checks information indicating payment is to be made by a plurality of users, and content of the desired commercial transaction has been changed within a desired time period since performing the credit inquiry, and instruct payment of the commercial transaction based on the results of the determination.

According to at least one example embodiment, the at least one processor may be further configured to execute the computer readable instructions to determine whether the response includes the separate checks information and information indicating that new commercial transactions were generated for the plurality of users excluding the user who responded to the first request, transmit a second request to each of the terminal apparatuses associated with the other users, the second request including requests for payment for the respective new commercial transactions, receive second responses to the second request from the terminal apparatuses associated with the other users, including credit card information associated with the other users, perform credit inquiries on the credit card information provided in the received second responses, and change the content of the desired commercial transaction based on a result of the credit inquiries performed.

According to at least one example embodiment, the at least one processor may be further configured to execute the computer readable instructions to identify a commercial transaction, to which payment is to be made among the newly generated commercial transactions, based on the performed credit inquiries, and change the content of the desired commercial transaction based on the content of the identified commercial transaction.

According to at least one example embodiment, the system may include wherein the second request may include separate checks amounts which are amounts of the commercial transactions newly generated for the other users.

According to at least one example embodiment, the system may include wherein the separate checks amounts may be amounts which are designated to the other users or the amount which is calculated by evenly dividing an amount of the desired commercial transaction by a number of the plurality of users.

According to at least one example embodiment, the at least one processor may be further configured to execute the computer readable instructions to pay the commercial transactions generated for the users by paying electronic money corresponding to amounts of the commercial transactions to the user who responded to the first request when the other users include users who desire to pay using electronic payment.

According to at least one example embodiment, the at least one processor may be further configured to execute the computer readable instructions to instruct payment of the desired commercial transaction in a case where although the response to the first request includes the separate checks information, the content of the desired commercial transaction is not changed and the desired time period has passed since performing the credit inquiry.

According to an aspect of the inventive concepts according to at least one example embodiment, an information processing method may include transmitting, using at least one processor, a first request to a first terminal apparatus, the first request including a request for payment of a desired commercial transaction, receiving, using the at least one processor, a response to the first request from the first terminal apparatus, the response including an approval of paying for the desired commercial transaction, performing, using the at least one processor, a credit inquiry on a credit card to be used for a transaction related to a desired commercial transaction, determining, using the at least one processor, whether the response includes separate checks information, the separate checks information indicating payment is to be made by a plurality of users, and content of the desired commercial transaction has been changed within a desired time period since performing the credit inquiry, and instructing payment, using the at least one processor, of the commercial transaction based on the results of the determining.

According to at least one example embodiment, the determining may include determining, using the at least one processor, whether the response includes the separate checks information and information indicating that new commercial transactions were generated for the plurality of users excluding the user who responded to the first request, transmitting, using the at least one processor, a second request to each of the terminal apparatuses associated with the other users, the second request including requests for payment for the respective new commercial transactions, receiving, using the at least one processor, second responses to the second request from the terminal apparatuses associated with the other users, including credit card information associated with the other users, performing, using the at least one processor, credit inquiries on the credit card information provided in the received second responses, and changing, using the at least one processor, the content of the desired commercial transaction based on a result of the credit inquiries performed.

According to at least one example embodiment, the method may include identifying, using the at least one processor, a commercial transaction, to which payment is to be made among the newly generated commercial transactions, based on the performed credit inquiries, and changing, using the at least one processor, the content of the desired commercial transaction based on the content of the identified commercial transaction.

According to at least one example embodiment, the method may include wherein the second request includes separate checks amounts which are amounts of the commercial transactions newly generated for the other users.

According to at least one example embodiment, the method may include wherein the separate checks amounts are amounts which are designated to the other users or the amount which is calculated by evenly dividing an amount of the desired commercial transaction by a number of the plurality of users.

According to at least one example embodiment, the method may include paying, using the at least one processor, the commercial transactions generated for the users by paying electronic money corresponding to amounts of the commercial transactions to the user who responded to the first request when the other users include users who desire to pay using electronic payment.

According to at least one example embodiment, the method may include instructing payment, using the at least one processor, of the desired commercial transaction in a case where although the response to the first request includes the separate checks information, the content of the desired commercial transaction is not changed and the desired time period has passed since performing the credit inquiry.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 illustrates an example configuration of a payment management system according to at least one example embodiment;

FIG. 2 illustrates an outline of the processes of the payment management system according to at least one example embodiment;

FIG. 3 illustrates an example hardware configuration of a computer according to at least one example embodiment;

FIG. 4 illustrates an example process block diagram of the payment management system according to at least one example embodiment;

FIG. 5 illustrates an example configuration of a user ID table according to at least one example embodiment;

FIG. 6 illustrates an example configuration of a transaction information table according to at least one example embodiment;

FIG. 7 is a sequence diagram of an example of a separate check payment process according to at least one example embodiment;

FIG. 8A illustrates an example setting screen to set a payment method according to at least one example embodiment;

FIG. 8B illustrates an example setting screen to set a user who shares separate check payment according to at least one example embodiment;

FIG. 9A illustrates an example separate checks request screen according to at least one example embodiment;

FIG. 9B illustrates an example payment method setting screen according to at least one example embodiment;

FIG. 10 illustrates an example process block diagram of a payment management system according to at least one example embodiment;

FIG. 11 illustrates another example configuration of the transaction information table according to at least one example embodiment; and

FIG. 12 is a sequence diagram of another example of the separate check payment process according to at least one example embodiment.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In related technologies, in order for a plurality of users to pay by separate checks, it is necessary to pay with a credit card of a specific credit card company. That is, it is necessary for a representative user, who pays the full amount first, to have a credit card of such a specific credit card company. There are, however, many credit cards issued from various card companies and/or alternative payment methods, such as debit cards, gift cards, rewards points, loyalty points, crypto-currency (e.g., Bitcoin), account information, etc. Therefore, it is desired that the payment by separate checks can be done without being limited to specific credit cards.

Therefore, there is provided a server which can send requests to pay the amounts, which are determined on a separate check basis, to the respective card companies of the credit cards owned by the users, so that the server sends the requests to the card companies to pay the amounts determined on the separate check basis after the payment by the representative user is settled.

In this case, however, if there exists, for example, a user whose payment amount, which is determined by the separate checks, exceeds the credit line (credit card expense limit) of the user, it is not possible for the user to pay the payment amount. As a result, a problem may occur that the total amount, which is to be paid by the separate checks, differs from the payment amount of the goods actually purchased, etc.

Various example embodiments of the inventive concepts are presented in light of the above problem, and may provide a system that makes it possible to correctly pay by separate check using a plurality of credit cards.

In the following, various example embodiments are described in detail with reference to the accompanying drawings.

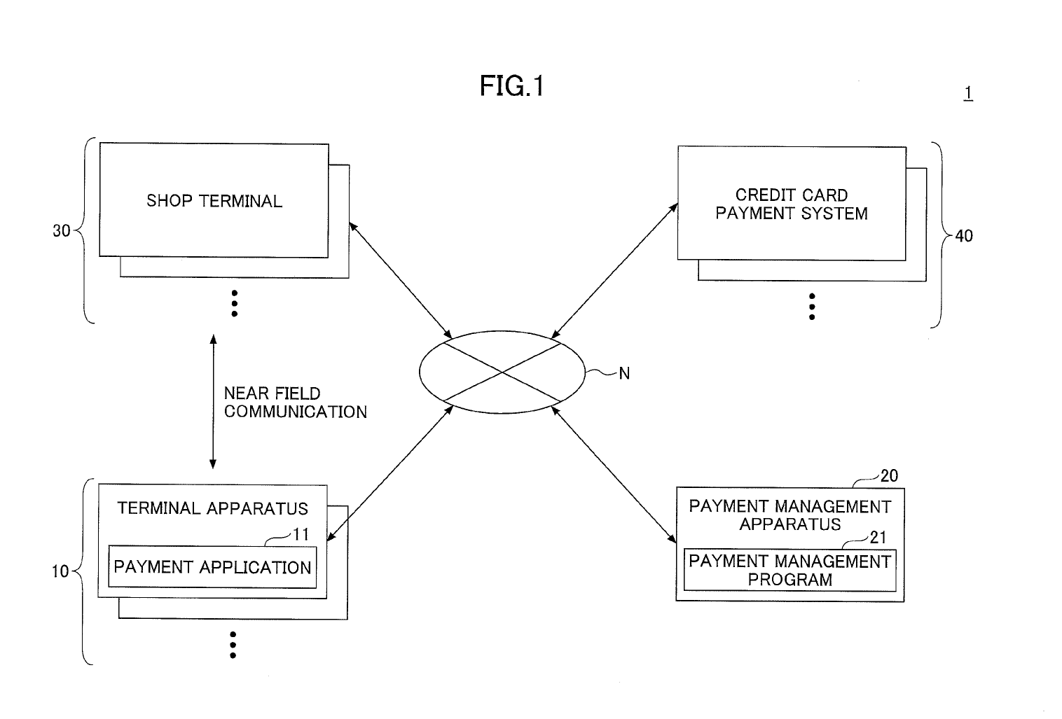

FIG. 1 illustrates an example configuration of a payment management system 1 according to at least one example embodiment. The payment management system 1 of FIG. 1 includes a plurality of terminal apparatuses 10, a payment management apparatus 20, at least one shop terminal 30, and at least one electronic payment system (e.g., a credit card payment system, bank account payment system, electronic wire transfer system, vendor specific financial transaction system, loyalty rewards program, crypto-currency transaction system, etc., hereinafter referred to as “credit card payment system”) such as credit card payment system 40, which are connected to each other via a wide-area network N such as the Internet, an intranet, a LAN, a WAN, a PAN, a cellular network, a communications network, a data network, etc., so as to communicate with each other. Further, the terminal apparatus 10 is connected to the shop terminal 30 so as to communicate with each other by using, for example, Near Field Communication (NFC), Bluetooth, IR, wired connections, wireless connections, barcode scanner, etc.

The terminal apparatus 10 may be a smartphone, a tablet terminal, a wearable terminal, a laptop Personal Computer (PC), a desktop PC, a smart device, etc., by which a user performs payment by a credit card. The terminal apparatus 10 includes a payment application 11 installed therein, so that, by using the payment application 11, a user can use a payment service to pay by an electronic payment method, such as a credit card, debit card, gift card, electronic wire transfer, bank account charges, other financial account charges, video game service account, social network account, instant messaging account, online account, etc. Further, the user can arrange payment by separate checks with the other user(s).

The payment application 11 of the terminal apparatus 10 manages a user ID, which uniquely identifies the user who uses the terminal apparatus 10 in the payment management system 1. In the following, the terminal apparatuses 10 of a user “A”, a user “B”, and a user “C” are called “terminal apparatus 10-1”, “terminal apparatus 10-2”, and “terminal apparatus 10-3”, respectively. Further, the user IDs applied to the user “A”, the user “B”, and the user “C” are called “user_id_a”, “user_id_b”, and “user_id_c”, respectively. While only three users/terminal apparatuses are discussed in connection with the example embodiments, the inventive concepts are not limited thereto and may be applied to any number of users and/or terminal apparatuses.

Further, the above user ID and the payment application 11 may be commonly used with other services. In other words, the payment application 11 may be integrated with and/or used in connection with other services and/or applications. The other service may include an Instant Messenger (IM) service, a Social Network Service (SNS) service, an email service, a video game service, etc.

The payment management apparatus 20 includes one or more information processing apparatuses (e.g., computers, specialized processing devices, etc.) and a payment management program 21 installed therein. The payment management apparatus 20 controls the processes which are related to various payments of the payment management system 1 by using the payment management program 21. For example, in response to a request from the shop terminal 30, the payment management apparatus 20 sends a request for payment to the terminal apparatus 10. Further, for example, in response to a request from the terminal apparatus 10, the payment management apparatus 20 sends a request of payment by separate checks to other terminal apparatuses 10.

The shop terminal 30 refers to, for example, a terminal such as a Point of sale (POS) terminal installed in a shop. The shop terminal 30 may include, for example, an NFC reader so as to communicate with the terminal apparatus 10 using the NFC. Further, the shop terminal 30 manages a shop ID, which uniquely identifies the shop in the payment management system 1.

Note that the shop terminal 30 is not limited thereto. For example, the shop terminal 30 may be used in an on-line transaction system, which performs an on-line transaction such as an e-commerce transaction. That is, some example embodiments may also be applied to a case where, for example, a payment for goods, which are purchased by communicating with an on-line transaction system via a network N, is made by separate checks by the terminal apparatus 10.

The credit card payment system 40 refers to a payment system of a credit card company, bank, financial institution, and/or other account providing services (hereinafter simplified as a “card company”). In the following, the credit card payment systems 40 of a card company “A”, a card company “B”, and a card company “C” are called a “credit card payment system 40-1”, a “credit card payment system 40-2”, and a “credit card payment system 40-3”, respectively. Outline of process

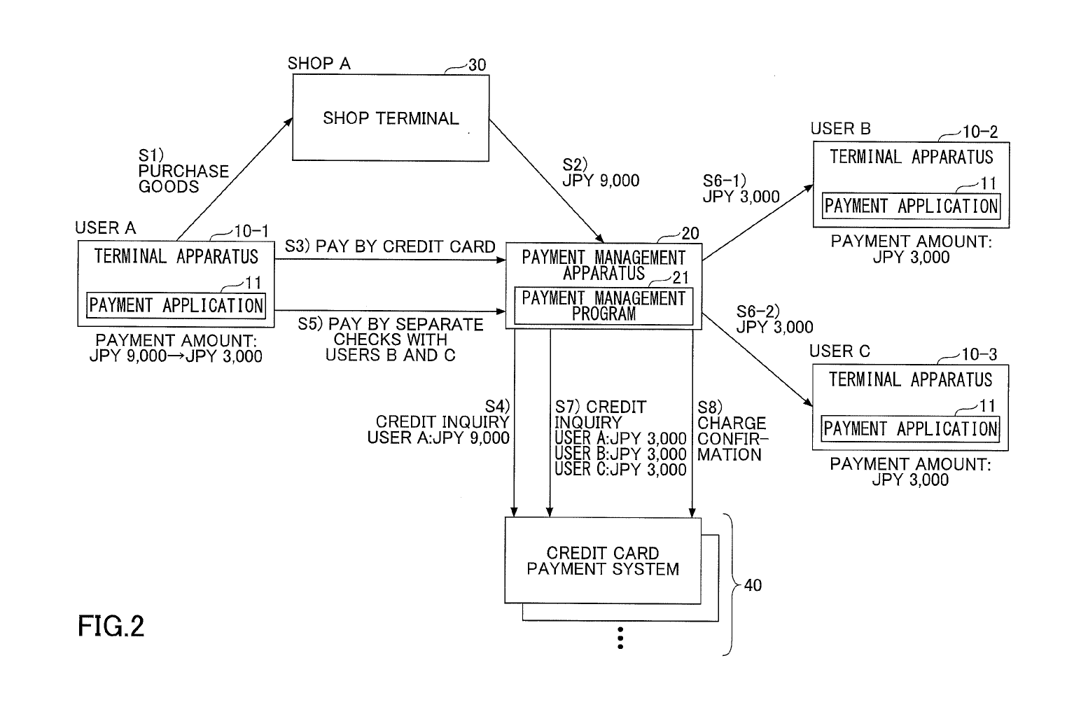

Next, an outline of the process performed in the payment management system 1 according to some example embodiments is described. FIG. 2 illustrates an outline of the processes performed in the payment management system 1 according to at least one example embodiment. With reference to FIG. 2, a case is described where a payment, which is made first by a credit card of the user “A” by using the terminal apparatus 10-1, is settled (made) by separate checks by the user “B” (terminal apparatus 10-2) and the user “C” (terminal apparatus 10-3) by using the respective credit cards.

First, the user “A” purchases goods in a shop “A” by using the terminal apparatus 10-1 (step S1). In response, the shop terminal 30 of the shop “A” reports the purchase amount “JPY (Japanese Yen) 9,000”, which is for the purchased goods using the terminal apparatus 10-1, to the payment management apparatus 20 (step S2).

Further, the user “A” uses the terminal apparatus 10-1, and reports that the above purchase amount is to be paid by credit card to the payment management apparatus 20 (step S3). In response, the payment management apparatus 20 conducts a credit inquiry on the payment amount “JPY 9,000” relative to the credit card payment system 40 of the card company of the credit card used for the payment by the user “A” (step S4).

Here, the term “credit inquiry” may also be referred to as “authorization” or “provisional charge”, and refers to a creditability confirmation ((card) validity check and allowable (credit) limit or available funds check) of the card user performed for the card company. When the “credit inquiry” is accepted by the card company, the payment mount is temporarily (provisionally) secured.

Next, the terminal apparatus 10-1 of the user “A” reports that the purchase amount “JPY 9,000” for the goods is to be paid by separate checks by three persons including the user “B” and the user “C” to the payment management apparatus 20 (step S5). In response, the payment management apparatus 20 transmits the purchase amount “JPY 3,000”, which is the payment amount when the purchase amount “JPY 9,000” is paid by separate checks by the three users “A”, “B”, and “C”, to the terminal apparatus 10-2 and the terminal apparatus 10-3 (steps S6-1 and S6-2).

Next, when the purchase amount, which is to be paid by separate checks with credit cards (and/or other electronic payment methods) by each of the users “B” and “C”, is accepted, the payment management apparatus 20 conducts a credit inquiry (and/or account inquiry) on the payment amount “JPY 3,000” relative to the credit card payment system 40 of the card companies of the credit cards used for the payment by the users “A”, “B” and “C”. In this case, the credit card payment systems 40 changes the payment amount (“JPY 9,000”) on which the credit inquiry is conducted of the user “A” in step S4 into “JPY 3000” (step S7). In this case, the payment management apparatus 20 conducts a credit inquiry on the payment amount (“JPY 3,000”) to be paid by separate checks relative to the credit card payment systems 40-1 through 40-3 of the credit cards used for the payment by the users “A”, “B” and “C”.

When the credit inquiry conducted in step S7 is accepted by each of the credit card payment systems 40-1 through 40-3, the charge confirmation of the payment amount (“JPY 3,000”) is conducted on each of the credit card payment systems 40-1 through 40-3.

Here, the term “charge confirmation” may also be called, for example, “capture” or “sales invoice”, and refers to the confirmation of the payment amount to be paid by credit card which was temporarily secured based on the acceptance of the credit inquiry.

By doing as described above, it becomes possible to pay the purchase amount (JPY 9,000), which is for purchasing goods by using the credit card of the user “A”, by separate checks, so that the payment amount (JPY 3000), which is determined by separate checks by the users “A”, “B”, and “C”, can be paid by the respective credit cards. Further, the processes of the payment by separate checks are controlled by the payment management apparatus 20 as described above, and the types and the card companies of the credit cards used by the users “A”, “B”, and “C” are not limited to specific types of payment methods and/or card companies. Therefore, it becomes possible for the users to use their desired payment methods.

### Hardware Configuration

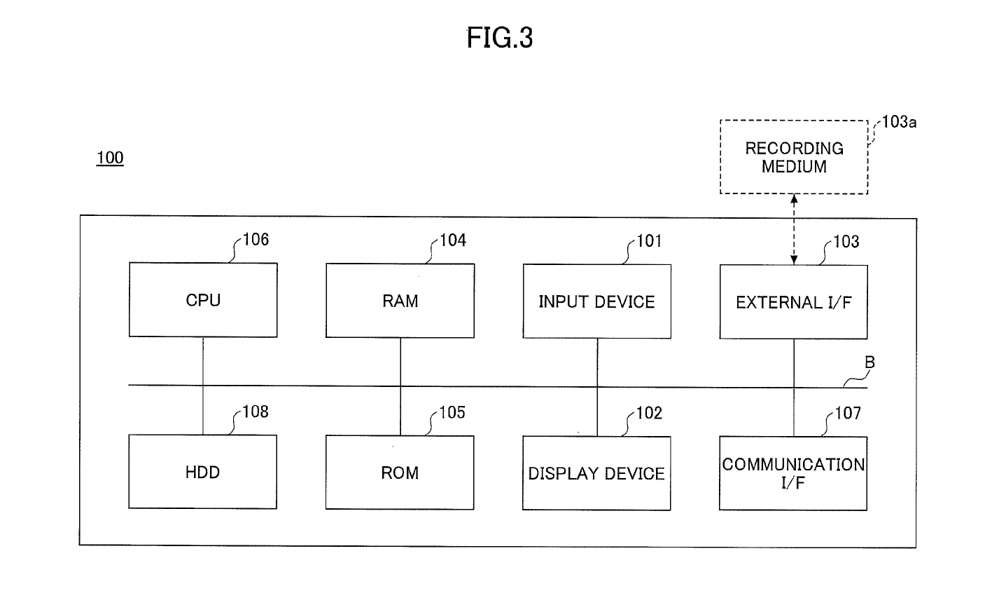

Next, a hardware configuration of the terminal apparatus 10 and the payment management apparatus 20 included in the payment management system 1 according to at least one example embodiment is described. The terminal apparatus 10 and the payment management apparatus 20 are realized by, for example, a computer 100 which has a hardware configuration of FIG. 3. FIG. 3 illustrates an example hardware configuration of the computer 100 according to at least one example embodiment.

The computer 100 of FIG. 3 includes an input device 101, a display device 102, an external interface (I/F) 103, a Random Access Memory (RAM) 104, and a Read-Only Memory (ROM) 105. The computer 100 further includes a Central Processing Unit (CPU) 106 (and/or specialized processing device), a communication I/F 107, and a storage device, such as a Hard Disk Drive (HDD) 108, or other storage device type. Those elements are connected to each other via a bus B.

The input device 101 includes a keyboard, a mouse, a touch panel, etc., and is used to input various operation signals by a user. The display device 102 includes a display, and displays results of processing performed by the computer 100. Note that, the input device 101 and the display device 102 may be connected to be used on an as needed basis.

The communication I/F 107 is an interface so that the computer 100 can be connected to a network. Via the communication I/F 107, the computer 100 can perform data communications. Further, the communication I/F 107 includes an NFC chip, Bluetooth chip, etc., to communicate with the shop terminal 30, e.g., perform Near Field Communication.

The HDD 108 is an example of a non-volatile storage device storing programs and data. The stored programs and data include an Operating System (OS), which is a fundamental software to control the entire computer 100, application software programs (e.g., the payment application 11 and the payment management program 21) which provide various functions on the OS, etc. In place of the HDD 108, the computer 100 may use a driving device (e.g., a Solid State Drive (SSD)) which uses a flash memory as a recording medium, or other non-volatile storage types.

The HDD 108 manages the stored programs and data based on a predetermined file system and/or a database (DB). The external I/F 103 is an interface with an external device. The external device includes a recording medium 103a, etc. The computer 100 can read and/or write data from and/or to the recording medium 103a via the external I/F 103. The recording medium 103a includes a flexible disk, a Compact Disc (CD), a Digital Versatile Disc (DVD), an SD memory card, a Universal Serial Bus (USB) Memory, etc.

The ROM 105 is a non-volatile semiconductor memory (storage device) which can hold programs and data stored therein even when power supplied thereto is cut off. The ROM 105 stores a Basic Input/Output System (BIOS) which is executed when the computer 100 starts up, OS settings, programs and data for network settings, etc. The RAM 104 is a volatile semiconductor memory (storage device) which temporarily stores programs and data.

The CPU 106 is a processing device that controls the entire computer 100 and realizes the functions of the computer 100 by loading programs (e.g., computer readable instructions) and data from a storage device such as the ROM 105 and the HDD 108 and executing processes. Once the program instructions are loaded into the CPU 106, the CPU 106 is programmed to perform the program instructions, thereby transforming the CPU 106 into a special purpose processor.

Additionally, while only a single input device 101, display device 102, external interface 103, RAM 104, ROM 105, CPU 106, communication interface 107, storage device 108, and bus “B” are depicted in FIG. 3, the example embodiments of the inventive concepts are not limited thereto. In other example embodiments, there may be more or less components installed in the computer 100, and each of the components of the computer 100 may number two or more.

The terminal apparatus 10 and the payment management apparatus 20 according to some example embodiments can realize various processes described below by having the hardware configuration of the computer 100.

### Software Configuration

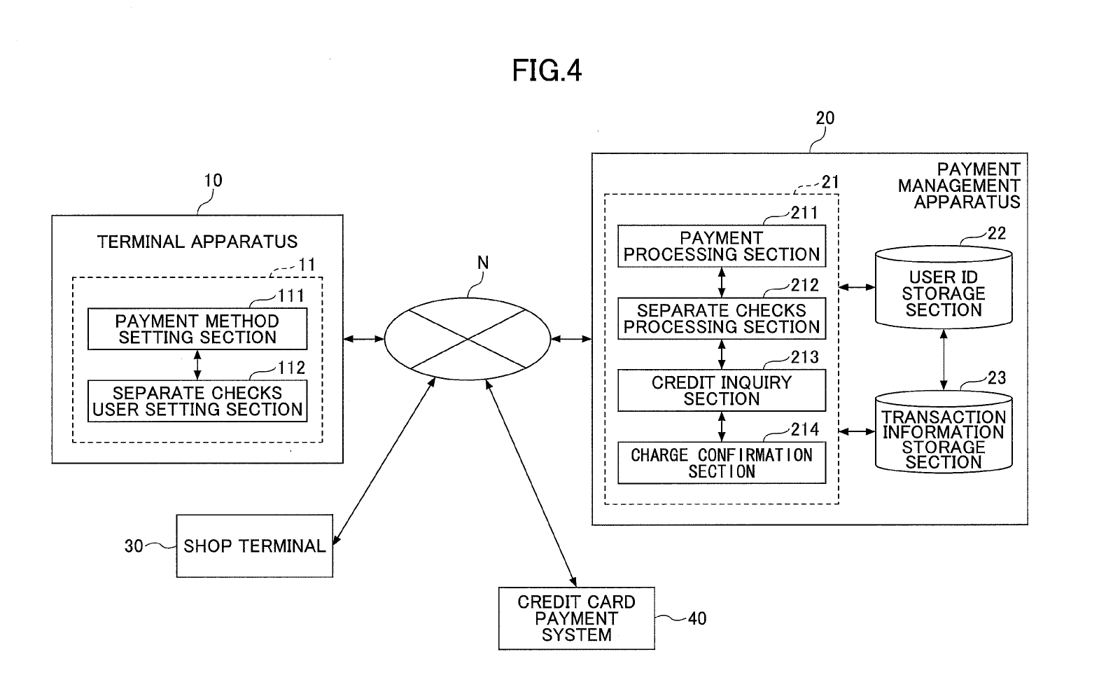

Next, an example software configuration of the payment management system 1 according to at least one example embodiment is described. FIG. 4 is a process block diagram of an example of the payment management system 1 according to at least one example embodiment. As described above, the terminal apparatus 10 includes the payment application 11 installed therein to use the payment service. Further, the payment management apparatus 20 includes the payment management program 21 installed therein to control the processes related to various payments. Further, the payment management apparatus 20 includes and uses a user ID storage section 22 and a transaction information storage section 23.

The payment application 11 of the terminal apparatus 10 includes a payment method setting section 111 and a separate checks user setting section 112. Those sections can be realized by, for example, executing the payment application 11 by the CPU 106.

The payment method setting section 111 sets the payment method of paying for goods, etc., purchased via the shop terminal 30. The payment method, which is set by the payment method setting section 111, includes items such as “whether the purchase amount is paid by electronic money or credit card”, “whether the purchase amount is paid by separate checks with other users or not”, etc.

The separate checks user setting section 112 sets the users who are to pay by separate checks when it is set that the purchase amount is to be paid by separate checks with other users by the payment method setting section 111.

The payment management program 21 of the payment management apparatus 20 includes a payment processing section 211, a separate checks processing section 212, a credit inquiry section 213, and a charge confirmation section 214. Those sections can be realized by, for example, executing the payment management program 21 by the CPU 106. Further, the user ID storage section 22 and the transaction information storage section 23 are realized by, for example, a storage device connected to the HDD 108 or the payment management apparatus 20 via a network

The payment processing section 211 performs processing related to the payment of the transaction conducted between the terminal apparatus 10 and the shop terminal 30. For example, upon receiving a request for payment from the shop terminal 30, the payment processing section 211 sends a request for the payment to the corresponding terminal apparatus 10.

The separate checks processing section 212 performs processing to make a payment amount, which is related to the transaction conducted between the terminal apparatus 10 and the shop terminal 30, to be paid by separate checks by a plurality of users. For example, the separate checks processing section 212 sends a request to the payment processing section 211, so that the payment processing section 211 sends a payment request to the users who are to pay the respective purchase amounts in the payment by separate checks to pay the respective purchase amounts.

The credit inquiry section 213 conducts a credit inquiry on a credit card relative to the credit card payment system 40.

The charge confirmation section 214 confirms the payment amount of the credit card, which is accepted by the credit inquiry, relative to the credit card payment system 40.

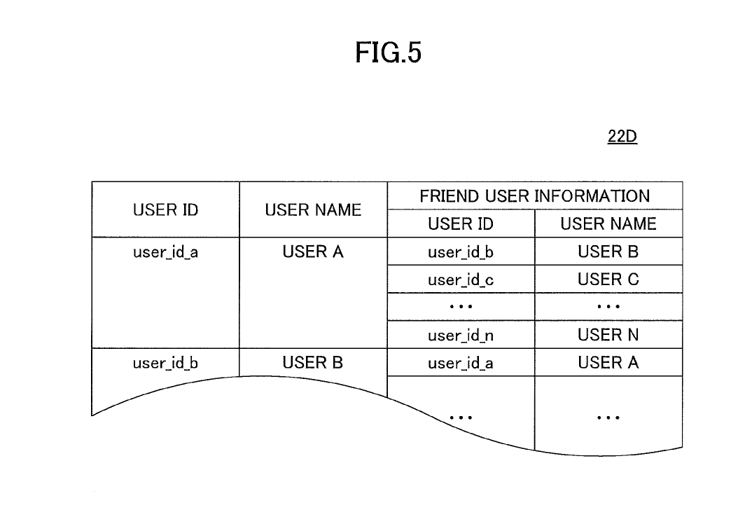

The user ID storage section 22 stores a user ID table 22D. For example, the user ID table 22D has the data items as illustrated in FIG. 5. That is, the user ID table 22D includes the data items, a “user ID”, which uniquely identifies the user who uses the terminal apparatus 10, a “user name”, which corresponds to the “User ID”, and “friend user information” which is the information indicating the users who are the friends of the user of the “User ID”. For example, the first record of the user ID table 22D indicates that the user of the user ID “user_id_a” has the user name “User “A”” and has his/her friends “User “B””, “User “C””, etc. In some example embodiments, it is assumed that the users included in the friend user information are candidates of the users who may pay by separate checks with the user of the user ID. That is, for example, when the purchase amount of the goods, which is purchased (transacted) by credit card by the user “A” (transaction user), is paid by separate checks with other users, the user “A” selects one or more users who are to pay by separate checks with the user “A” from the users included in the friend user information. The friend user information may be populated using friend information from a social networking service, an instant messaging service, an electronic contact list (e.g., phone contact list, email contact list, etc.), online gaming service, etc., and/or may be friend information that was input by the user into the payment application 11.

For example, the users who are to pay by separate checks with the transaction user are not limited to the users who are the friends of the transaction user. A user, who belongs to a same chat group to which the transaction user belongs in an Instant Messaging (IM) service, or a user, who belongs to a same community to which transaction user belongs in a Social Networking Service (SNS), may also be a candidate of the users who are to pay by separate checks with the transaction user.

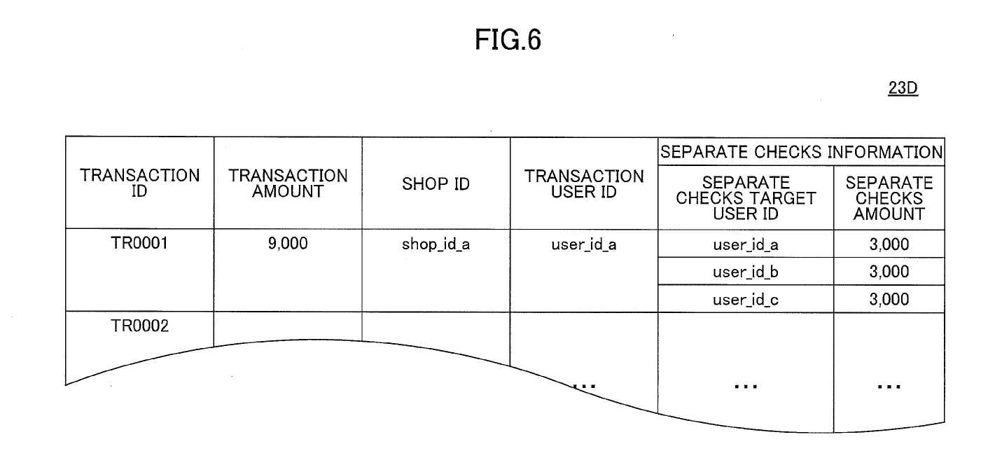

The transaction information storage section 23 stores a transaction information table 23D. For example the transaction information table 23D includes, the data items as illustrated in FIG. 6. That is, the data items of the transaction information table 23D include a “transaction ID”, which uniquely identifies the transaction performed by the transaction user, a “transaction amount”, which indicates the purchase amount for goods, etc., a “shop ID”, which indicates the shop where the transaction is performed, and a “transaction user ID” which indicates the user who performed the transaction.

The transaction information table 23D further includes a data item “separate checks information” which is used when the goods, which are purchased (transacted) by the transaction user by credit card, are to be paid for by separate checks with other users. The “separate checks information” includes a “separate checks target user ID”, which indicates a target user who is involved in the payment by separate checks (“separate checks target user”), and a “separate checks amount” which is to be paid by the target user. For example, the transaction information table 23D of FIG. 6 illustrates a record of the transaction, whose “transaction user ID” is “TR0001”, indicating that the “transaction amount”, which is JPY 9,000, based on the transaction performed by the user “A”, whose “transaction user ID” is “user_id_a”, is to be paid by separate checks by the users “A”, “B”, and “C”, so that JPY 3,000 is to be paid separately by the users “A”, “B”, and “C” (see “separate checks amount” of FIG. 6). Further, the “separate checks information” is set in the terminal apparatus 10 by setting the target users of the payment by separate checks by the transaction user via the separate checks user setting section 112 of the terminal apparatus 10.

### Details of the Processes

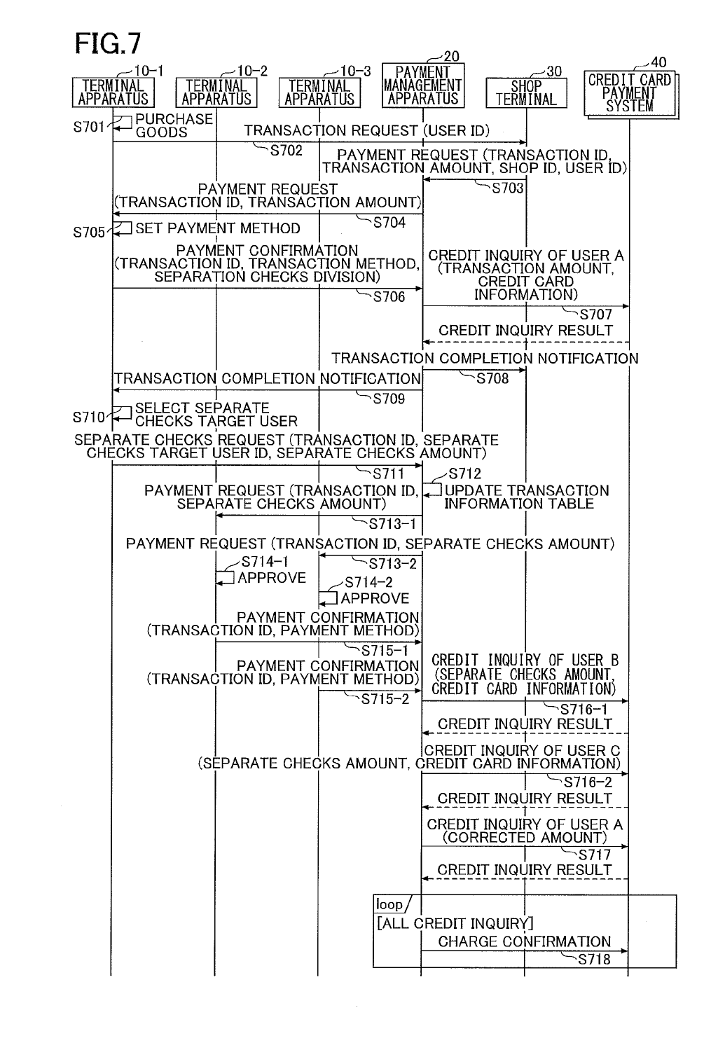

Next, details of the processes performed by the payment management system 1 according at least one example embodiment are described with reference to FIG. 7. FIG. 7 is a sequence diagram of an example of a separate checks payment process according to at least one example embodiment. In the following, similar to the case described with reference to FIG. 2, the case is described where the payment, which is (provisionally) made by credit card by using the terminal apparatus 10-1 by the user “A”, is made by separate checks with the credit cards of the user “B” (using the terminal apparatus 10-1) and the user “C” (using the terminal apparatus 10-2).

First, for example, the user “A” uses the terminal apparatus 10-1 and purchases goods in a shop “A” (step S701). To that end, for example, a clerk of the shop “A” inputs the amount (transaction amount) of the goods in the shop terminal 30, and then, the user “A” places the terminal apparatus 10-1 on or over a desired and/or predetermined position of the shop terminal 30 (so that the Near Field Communication can be used with the terminal apparatus 10-1).

Then, the terminal apparatus 10-1 sends a “transaction request”, which includes the user ID “user_id_a” of the user “A”, to the shop terminal 30 (step S702). Such a “transaction request” is transmitted by the Near Field Communication such as NFC.

Here, as the Near Field Communication, for example, Bluetooth Low Energy (BLE) may be used. The processes in steps S701 and S702 are not limited to the case where a user purchases goods in a shop, and can also be applied to a case where, for example, a user pays for a service (e.g., a food delivery service), or may be applied to personal transactions between two or more people.

In this regard, in a case where the user “A” uses the terminal apparatus 10-1 and pays on an on-line transaction (Web) site such as E-commerce, etc., the terminal apparatus 10-1 sends the “transaction request”, which includes the “user ID” of the user “A”, to the on-line transaction system via the network N.

Upon receiving the “transaction request”, the shop terminal 30 determines (employs) the number which is unique for each of the shops in the payment management system 1. Then, the shop terminal 30 transmits a “payment (settlement) request”, which includes the “transaction ID”, the “transaction amount”, the “shop ID” of the shop “A”, and the “user ID” included in the “transaction request” (which becomes the “transaction user ID”) to the payment management apparatus 20 (step S703). Here, it is assumed that the data are included which are “TR0001” as the data of the “transaction ID”, “9,000” as the data of the “transaction amount”, “shop_id_a” as the data of the “shop ID” and “user_id_a” as the “transaction user ID”.

Further, as the processes of steps S702 and S703, a case is described where the shop terminal 30 receives the “user ID” from the terminal apparatus 10, and transmits the “transaction ID”, “transaction amount”, “shop ID”, etc., to the payment management apparatus 20. Note that, however, that the example embodiments are not limited thereto. For example, in the processes of steps S702 and S703, the terminal apparatus 10 may receive the “transaction ID”, “transaction amount”, “shop ID”, etc., from the shop terminal 30, and transmits them along with the “user ID” to the payment management apparatus 20.

Upon receiving the “payment request”, the payment processing section 211 of the payment management apparatus 20 transmits the “payment request”, which includes the “transaction ID” and the “transaction amount”, to the terminal apparatus 10-1 of the transaction user of “user_id_a” (i.e., the user “A”) (step S704). Further, in this case, the payment processing section 211 of the payment management apparatus 20 generates the transaction information based on the “transaction ID”, the “transaction amount”, the “shop ID”, and the “user ID” (“transaction user ID”), and stores the transaction information in the transaction information table 23D.

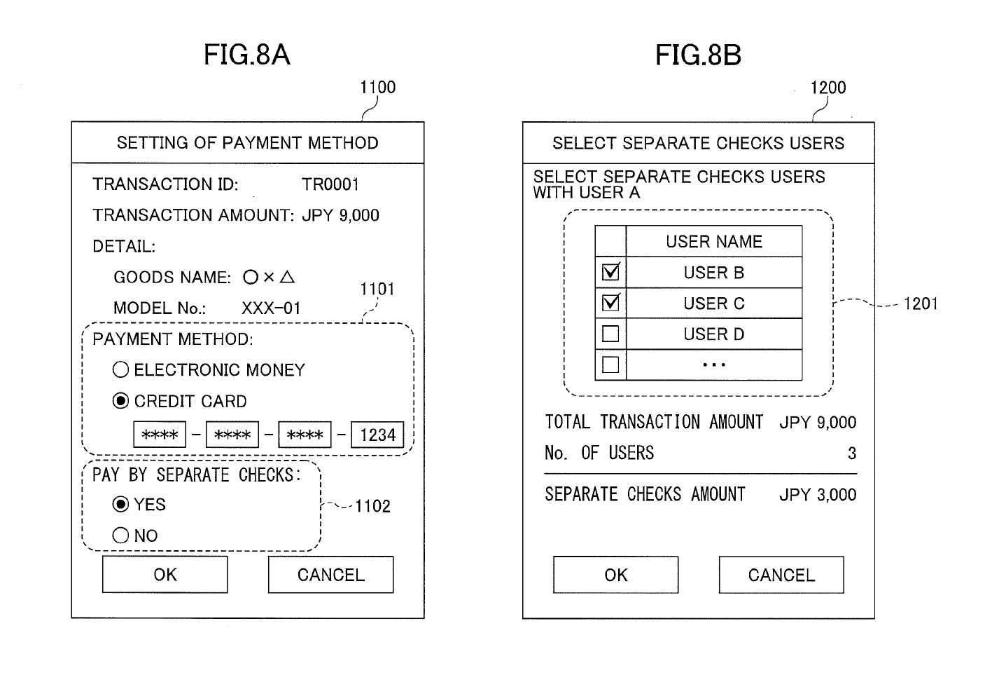

Upon receiving the “payment request”, the terminal apparatus 10-1 displays a setting screen 1100 to set a payment method as illustrated in FIG. 8A on the display device 102. The setting screen 1100 to set a payment method displays the “transaction ID”, “transaction amount”, a name of the goods, etc., which are related to the goods purchase by the user “A”, so that the user “A” can confirm that the transaction displayed on the setting screen 1100 is correct. Then, the user “A” sets (selects) the payment method, here for example, by “electronic money” or “credit card” in a payment method setting area 1101 of the setting screen 1100. Further, the user “A” sets (selects) where the payment is to be made by separate checks with other user(s) in a separate checks setting area 1102 of the setting screen 1100, and then presses an “OK” button in the setting screen 1100 (step S705). Here, it is assumed that the “credit card” is selected and the information of the credit card (“credit card information”) is input in the payment method setting area 1101, and the payment by separate checks with other user(s) is selected in the separate checks setting area 1102.

Then, the payment method setting section 111 of the terminal apparatus 10-1 generates “payment confirmation” which includes the data “TR0001” as the “transaction ID”, “credit card” as the “payment method”, and “Yes” to pay by separate checks, and transmits the “payment confirmation” to the payment management apparatus 20 (step S706). Further, in this case, the payment method includes the “credit card information” (i.e., credit card No., security code, expiration date, etc.) set in step S705. Hereinafter, the credit card of a card company “A” used by the user “A” set in step S705 is referred to as “credit card “A””, and the credit card information of the “credit card “A”” is referred to as “credit card information “A””.

Upon receiving the “payment confirmation”, the credit inquiry section 213 of the payment management apparatus 20 transmits the “credit inquiry” to the credit card payment system 40-1 of the card company “A” based on the credit card information “A” included in the “payment confirmation” (step S707). Further, the “credit inquiry” includes the “transaction amount” and the “credit card information “A””. Further, when the “credit inquiry” is accepted, the payment management apparatus 20 receives a “credit inquiry result” indicating that the “credit inquiry” is accepted.

Upon receiving the “credit inquiry result” from the credit card payment system 40-1, the payment processing section 211 of the payment management apparatus 20 transmits a “transaction completion notification” to the shop terminal 30 and the terminal apparatus 10-1 (steps S708 and S709). By doing this, the purchase (transaction) of the goods by the user “A” with the credit card “A” is completed. As described above, when the transaction user sets (selects) that the purchase amount is to be paid by separate checks with other user(s), the transaction is completed at the stage when the “credit inquiry” is accepted. By doing this, it becomes possible to complete the transaction between the terminal apparatus 10 of the transaction user and the shop terminal 30.

Further, in a case where, in step S705, the user “A” sets in the separate checks setting area 1102 that the payment is not to be made by separate checks, after the “credit inquiry” is accepted in step S707, the charge confirmation section 214 of the payment management apparatus 20 performs the “charge confirmation” relative to the “credit inquiry”.

Next, the user “A” operates the terminal apparatus 10-1, and selects a user(s) who is to pay the purchase amount of the purchased goods by separate checks (step S710). To that end, the user “A” operates the terminal apparatus 10-1, and displays a separate checks payment user selection screen 1200 as illustrated in FIG. 8A on the display device 102. Then, the user “A” selects a user(s) who is to pay by separate checks in a separate checks payment user selection area 1201 and presses the “OK” button in the separate checks payment user selection screen 1200. Here, the user candidates to pay by separate checks displayed in the separate checks payment user selection area 1201 may be acquired from the friend user information in the user ID table 22D of the payment management apparatus 20, or may be acquired from the friend user information stored in a storage device of the terminal apparatus 10-1, etc.

FIG. 8B illustrates an example where the user “B” and the user “C” are selected in the separate checks payment user selection area 1201. In this case, the purchase amount for the goods is paid by separate checks by the three users, that is the “user “A””, the “user “B””, and the “user “C””. Accordingly, the purchase amount “JPY 9,000” is paid in a manner such that “JPY 3,000” is paid by each of the user “A”, the user “B”, and the user “C”.

Further, in case where the purchase amount cannot be divided evenly (e.g., when “JPY 10,000” is to be paid by separate checks by three users), it is set that the remainder amount is paid by a specific user (e.g., by the transaction user). Further, in the above description, the payment amount by separate checks is determined by dividing the purchase amount by the number of users. Note that, however, that the example embodiments are not limited thereto. For example, the payment amounts, which are to be paid by separate checks by the users, may be separately set (input) for each of the users. In other words, the amount to be paid by each of the users may be individually set to any desired amount and do not have to be co-equal.

The separate checks user setting section 112 of the terminal apparatus 10-1 generates a “separate checks request” which includes the “transaction ID”, a “separate checks payment user ID” corresponding to the user selected in step S710, and a “separate checks amount” corresponding the user of the “separate checks payment user ID”, and sends the “separate checks request” to the payment management apparatus 20 (step S711). Here, it is assumed that the data of the “transaction ID”, “separate checks payment user ID”, and the “separate checks amount” are “TR0001”, “user_id_b (i.e., the user “B”)” and “user_id_c (i.e., the user “C”)”, and “JPY 3,000”, respectively.

Upon receiving the “separate checks request”, the separate checks processing section 212 of the payment management apparatus 20 verifies the validity of the “separate checks payment user ID” and the “separate checks amount” included in the “separate checks request”, and then, updates the corresponding transaction information in the transaction information table 23D (step S712). Here, to the “separate checks information” of the “transaction information” whose data are “TR0001”, the data “user_id_a”, which is the user ID of the transaction user, and the data “user_id_b” and “user_id_c”, which are the separate checks target user IDs set in step S710, are added. Further, the data “JPY 3,000” of the separate checks amount are added for each of the users corresponding to the added separate checks target user IDs.

Here, the separate checks processing section 212 verifies the validity as described below.

The separate checks processing section 212 refers to the user ID table 22D, and determines whether the transaction user and the separate checks target user are mutual friends (or belong to the same group or community).

The separate checks processing section 212 determines whether the sum of the separate check amount of the transaction user and the separate checks amounts of the separate checks target users is equal to the purchase amount.

Further, the separate checks processing section 212 of the payment management apparatus 20 sends a request to the payment processing section 211, so that the payment processing section 211 transmits the “payment request”, which includes the “transaction ID” and the “separate checks amount”, to the terminal apparatuses 10 of the users who are included in the users corresponding to the “separate checks target user IDs” but excluding the transaction user. Further, the payment processing section 211 transmits the “payment request” to the terminal apparatuses 10. In this case, the payment processing section 211 of the payment management apparatus 20 transmits the “payment request” to the terminal apparatus 10-2 of the user “B” and the terminal apparatus 10-3 of the user “C” (step S713-1 and S713-2).

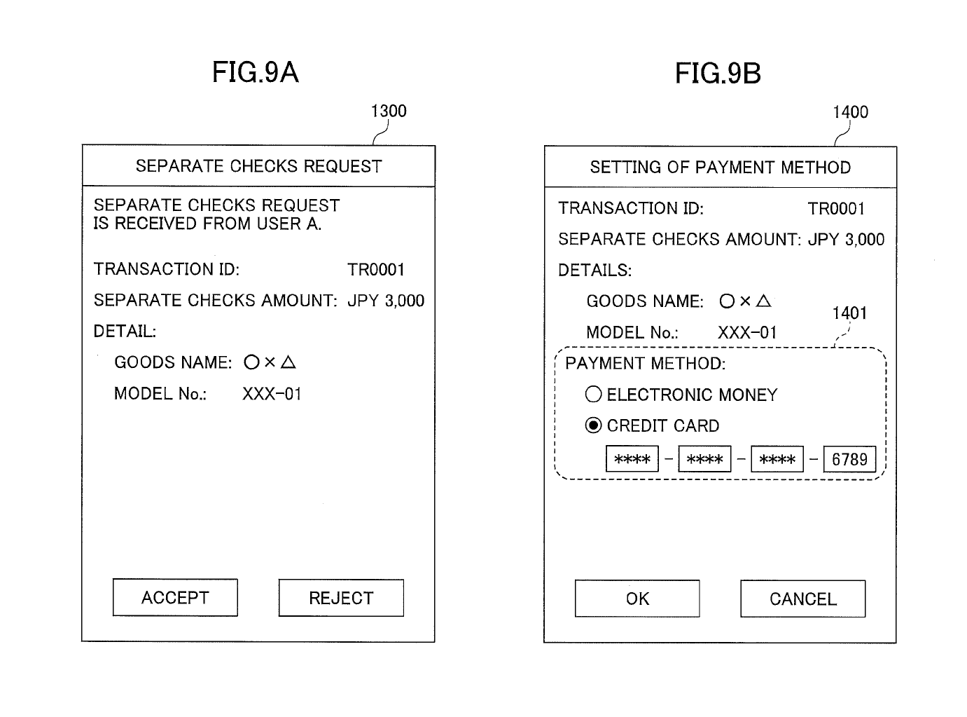

Upon receiving the “payment request”, the terminal apparatus 10-2 displays a separate checks request screen 1300 as illustrated in FIG. 9A on the display device 102. Then, the user “B” verifies the name of the transaction user (user “A”), the “transaction ID”, the “separate checks amount”, the name of the goods, etc., and presses the “accept” button to accept the payment of the “separate checks amount” by the user “B”.

Then, the terminal apparatus 10-2 changes the screen to display a payment method setting screen 1400 as illustrated in FIG. 9B. Then, the user “B” sets the payment method in the payment method setting area 1401 of the payment method setting screen 1400 by selecting either “electronic money” or “credit card”, and presses the “OK” button (step S714-1). Here, it is assumed that the “credit card” is selected as the payment method and the credit card information thereof is input in the payment method setting area 1401. The processes performed by the terminal apparatus 10-2 of user “C” are similar to the processes in step S714-1 (step S714-2).

Then, the payment method setting section 111 of the terminal apparatus 10-2 generates the “payment confirmation” which includes the data “TR0001” of the “transaction ID” and the data “credit card” of the “payment method”, and transmits the “payment confirmation” to the payment management apparatus 20 (step S715-1). Further, in this case, the “payment method” includes the “credit card information” set in step S714-1. Here, the credit card of the card company “B” used by the user “B” is called a “credit card “B””, and the credit card information of the “credit card “B”” is called a “credit card information “B””.

The processes performed by the terminal apparatus 10-3 of the user “C” are similar to those described above (step S715-2). Here, the credit card of the card company “C” used by the user “C” is called a “credit card “C””, and the credit card information of the “credit card “C”” is called a “credit card information “C””.

Upon receiving the “payment confirmation” from the terminal apparatus 10-2, the credit inquiry section 213 of the payment management apparatus 20 transmits the “credit inquiry” to the “credit card payment system 40-2” of the card company “B” based on the credit card information “B” included in the “payment confirmation” (step S716-1). Similarly, upon receiving the “payment confirmation” from the terminal apparatus 10-3, the credit inquiry section 213 of the payment management apparatus 20 transmits the “credit inquiry” to the “credit card payment system 40-3” of the card company “C” based on the credit card information “C” included in the “payment confirmation” (step S716-2).

Then, when those “credit inquiries” are accepted, the payment management apparatus 20 receives respective “credit inquiry results” from the “credit card payment system 40-2” and the “credit card payment system 40-3”.

When the acceptances of the “credit inquiries” are received from all the separate checks target users (user “B” and user “C”) excluding the transaction user, the credit inquiry section 213 of the payment management apparatus 20 changes the payment amount in the credit inquiry performed in step S707 (step S717). That is, the credit inquiry section 213 of the payment management apparatus 20 transmits the “credit inquiry”, in which the payment amounts of the “credit inquiry” in step S707 is changed into the separate checks amount (JPY 3,000 in this case), to the credit card payment system 40-1. When the “credit inquiry”, in which the payment amount is changed (corrected), is accepted, the payment management apparatus 20 receives the “credit inquiry result”, which indicate the acceptance, from the credit card payment system 40-1.

Depending on the card company, the payment amount may not be changed (corrected). In such a case, the “credit inquiry” performed in step S707 is cancelled, and a new “credit inquiry” of the payment amount which is equal to the separate checks amount is transmitted to the credit card payment system 40.

Finally, the charge confirmation section 214 of the payment management apparatus 20 performs (transmits) the “charge confirmation” relative to all the “credit inquiries” performed in steps S716-1, S716-2, and S717 to the credit card payment system 40 (step S718). By doing this, the charges of the separate checks amounts by the respective credit cards of the user “A”, the user “B”, and the user “C” are confirmed.

As described above, in the payment management system 1 according to some example embodiments, for example, it becomes possible to pay the amount of goods purchased by one user (transaction user) with separate checks by two or more users using the respective credit cards. Furthermore, it becomes possible for the two or more users who pays by separate checks to user the respective desired credit cards and/or other payment methods regardless of the types of the credit card and/or other payment methods.

Further, in the payment management system 1 according to some example embodiments, for example, in a case where the amount for goods purchased by the transaction user by credit card is to be paid by separate checks by a plurality of users, the transaction can be completed once when only the “credit inquiry” to the credit card of the transaction user is completed. Therefore, for example, it is not necessary for the shop which sold the goods to wait until all of the “credit inquiries” for all of the plurality of users who are to pay by separate checks are completed. Therefore, the transaction can be done quickly.

Next, a payment management system 1 according to at least one example embodiment is described. In the payment management system 1 according to some example embodiments, a case is described where, for example, the transaction user does not set any “separate checks target user”, a “separate checks target user” rejects to pay the separate checks amount, or a “separate checks target user” does not respond to the “payment request”.

### Software Configuration

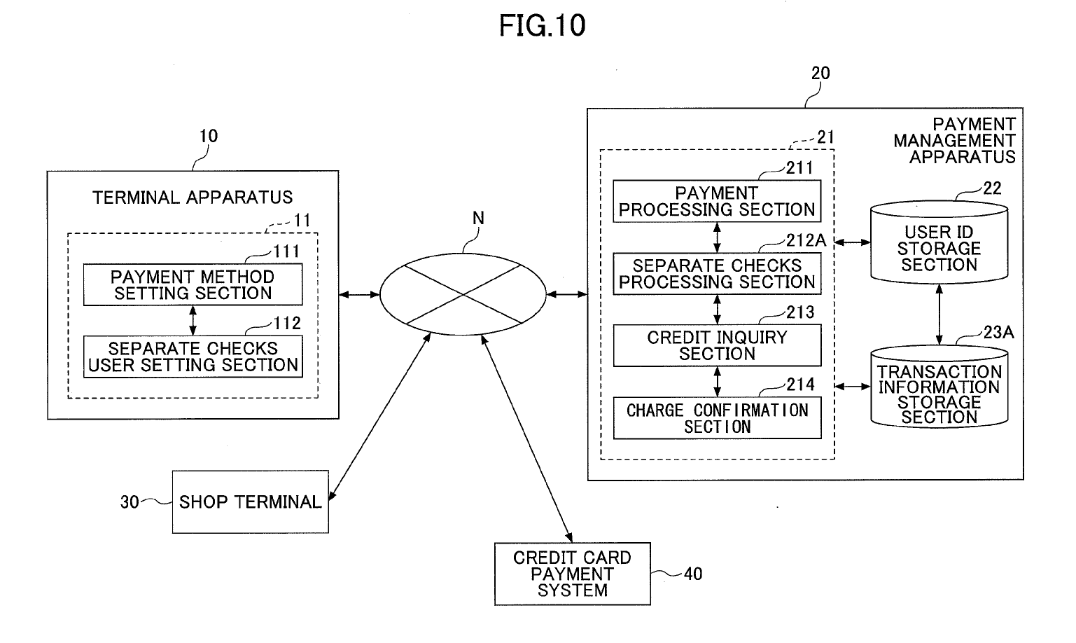

First, a software configuration of the payment management system 1 according to at least one example embodiment. FIG. 10 is a process block diagram of an example of the payment management system 1 according to at least one example embodiment. The payment management system 1 according to FIG. 10 differs from the payment management system 1 according to FIG. 4 in the presence of a separate checks processing section 212A and the data configuration of a transaction information table 23AD stored in a transaction information storage section 23A of the payment management apparatus 20. Therefore, in the following, basically, only those parts are described.

In addition to the functions described above, in a case where the transaction user does not set the separate checks target user for a desired and/or certain period of time, the separate checks processing section 212A sends a request to the charge confirmation section 214 so that the charge confirmation section 214 performs the “charge confirmation”. Further, in a case where, for example, the separate checks target user rejects the payment of the separate checks amount, the separate checks processing section 212A updates the separate checks amount of the transaction user in the transaction information table 23AD.

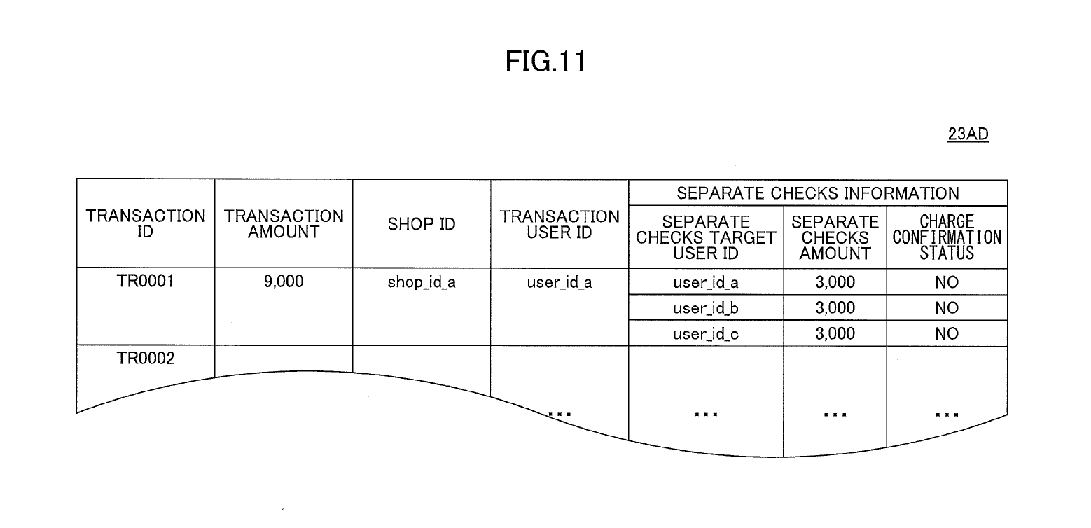

The transaction information storage section 23A stores the transaction information table 23AD. For example, the transaction information table 23AD includes data items as illustrated in FIG. 11. That is, in addition to the data items of the transaction information table 23D in FIG. 6, a data item “charge confirmation status” is added which indicates whether it is possible to perform the “charge confirmation” relative to the user of the “separate checks target user ID”.

The data of the “charge confirmation status” is set to “YES” when the payment management apparatus 20 receives the “credit inquiry result” which indicates that the “credit inquiry” of the credit card used for the payment by the transaction user is accepted. Therefore, when the payment management apparatus 20 receives the “credit inquiry result” which indicates that the transaction is not accepted or when the payment of the separate checks amount is rejected by the separate checks target user, the data of the “charge confirmation status” remains “NO”.

### Details of the Processes

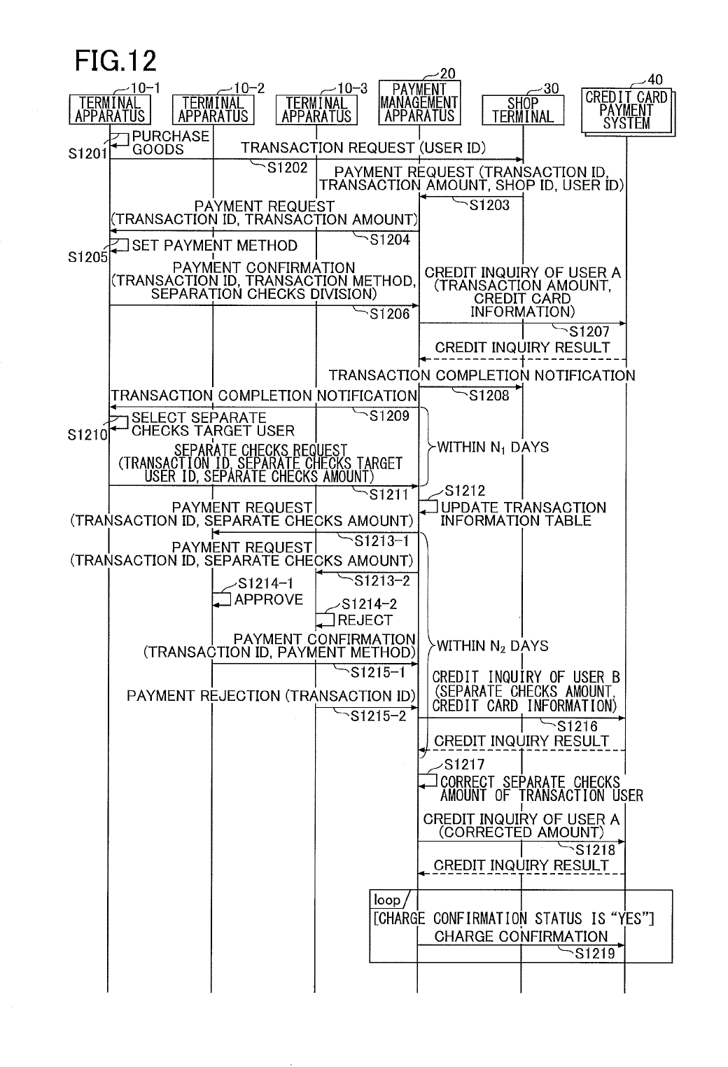

Next, details of the processes performed by the payment management system 1 according to at least one example embodiment are described with reference to FIG. 12. FIG. 12 is a sequence diagram of an example of a separate checks payment process according to some example embodiments. In the following, with reference to FIG. 12, a case is described where a separate checks target user “U” rejects the payment of the separate checks amount. The descriptions of the steps where the processes similar to those in FIG. 7 are performed may be simplified or omitted.

First, the user “A” uses the terminal apparatus 10-1, and purchases goods in the shop “A” (step S1201). Then, the terminal apparatus 10-1 sends a “transaction request”, which includes the “user ID” of the user “A”, to the shop terminal 30 (step S1202).

Upon receiving the “transaction request”, the shop terminal 30 determines (employs) the “transaction ID”, and sends the “transaction request”, which includes the “transaction ID”, to the payment management apparatus 20 (step S1203).

Upon receiving the “payment request”, the payment processing section 211 of the payment management apparatus 20 sends the “payment request”, which includes the “transaction ID” and the “transaction amount”, to the terminal apparatus 10-1 of the transaction user (user “A”) (step S1204).

Upon receiving the “payment request”, for example, the terminal apparatus 10-1 displays the setting screen 1100 to set a payment method on the display device 102. Then, the user “A” sets the payment method and whether to pay by separate checks with other user(s), and presses the “OK” button (step S1205). Here, it is assumed that the “credit card” is selected in the payment method setting area 1101 as the payment method and the relevant credit card information is input, and “YES” to pay by separate checks with other user(s) is selected in the separate checks setting area 1102.

As a response, the payment method setting section 111 of the terminal apparatus 10-1 generates the “payment confirmation”, and transmits the “payment confirmation” to the payment management apparatus 20 (step S1206).

Upon receiving the “payment confirmation”, the credit inquiry section 213 of the payment management apparatus 20 sends the “credit inquiry” to the credit card payment system 40-1 of the card company “A” of the credit card “A” (step S1207). When the “credit inquiry” is accepted, the payment management apparatus 20 receives the “credit inquiry result”, which indicates the acceptance of the “credit inquiry”, from the credit card payment system 40-1.

Upon receiving the “credit inquiry result” which indicates the acceptance of the “credit inquiry” from the credit card payment system 40-1, the payment processing section 211 of the payment management apparatus 20 sends the “transaction completion notification” to the shop terminal 30 and the terminal apparatus 10-1 (steps S1208 and S1209).

Next, the user “A” operates the terminal apparatus 10-1 and selects the users who are to pay the purchase amount of the purchased goods by a desired separate checks amount (separate checks amount) (step S1210). Then, the separate checks user setting section 112 of the terminal apparatus 10-1 generates the “separate checks request” and sends the “separate checks request” to the payment management apparatus 20 (step S1211).

Upon receiving the “separate checks request” from the terminal apparatus 10-1 within “N₁” units of time (e.g., minutes, hours, days, weeks, etc.) since sending the “transaction completion notification” to the terminal apparatus 10-1 (or the “credit inquiry” is conducted), the separate checks processing section 212A of the payment management apparatus 20 verifies the validity of the “separate checks target user ID” and the “separate checks amount” included in the “separate checks request”, and then, updates the corresponding transaction information in the transaction information table 23AD (step S1212). In this case, the data of the “charge confirmation status” in the transaction information table 23AD is updated to “NO”.

On the other hand, in step S1212, when “N₁” days have passed since the “transaction completion notification” has been sent to the terminal apparatus 10-1, the separate checks processing section 212A of the payment management apparatus 20 sends a request to the charge confirmation section 214 so that the charge confirmation section 214 performs the “charge confirmation” relative to the “credit inquiry” in step S1207. Then, the charge confirmation section 214 performs the “charge confirmation” relative to the “credit inquiry”. By doing this, in a case where no separate checks target user is set within “N₁” units of time since the terminal apparatus 10 of the transaction user has received the “transaction completion notification”, it is controlled so that all the purchase amount is to be paid by the transaction user. Therefore, it becomes possible to avoid a case where the “charge confirmation” has not been performed for a long term because the transaction user does not set the separate checks target user(s) for a long term. The “N₁” days may be set to any desired time period, such as one hour, two hours, one day, two days, etc. In the following description, it is assumed that the separate checks processing section 212A of the payment management apparatus 20 receives the “separate checks request” within “N₁” days (assuming the desired time period has been set to days) since the “transaction completion notification” is transmitted.

The separate checks processing section 212A of the payment management apparatus 20 sends a request to the payment processing section 211, so that the payment processing section 211 sends the “payment request” to the terminal apparatuses 10 of the separate checks target users excluding the transaction user. Then, the payment processing section 211 sends the “payment request” to the terminal apparatuses 10. In this case, the payment processing section 211 of the payment management apparatus 20 sends the “payment request” to the terminal apparatus 10-2 of the user “B” and the terminal apparatus 10-3 of the user “C” (steps S1213-1 and S1213-2).

Upon receiving the “payment request”, for example, the terminal apparatus 10-2 displays the separate checks request screen 1300 on the display device 102. Then, the user “B” verifies the content of the separate checks request screen 1300, and presses the “accept” button to accept the payment of his/her separate checks amount.

Then, for example, the terminal apparatus 10-2 changes the screen to display the payment method setting screen 1400. Then, the user “B” sets the payment method in the payment method setting area 1401 of the payment method setting screen 1400, and presses the “OK” button (step S1214-1). Here, it is assumed that the “credit card” is selected as the payment method and the credit card information thereof is input in the payment method setting area 1401. When the “electronic money” is selected in the payment method setting area 1401, it is desired that the electronic money corresponding to the separate checks amount of the user “B” is transmitted to the electronic money account of the user “A” and the separate checks amount of the user “B” is paid by the credit card “A” of the user “A”.

On the other hand, upon receiving the “payment request”, for example, the terminal apparatus 10-3 displays the separate checks request screen 1300 on the display device 102. Then, it is assumed that the user “c” verifies the content of the separate checks request screen 1300, and presses the “reject” button to reject the payment of his/her separate checks amount (step S1214-2).

Then, the payment method setting section 111 of the terminal apparatus 10-2 generates the “payment confirmation”, and transmits the “payment confirmation” to the payment management apparatus 20 (step S1215-1). On the other hand, the terminal apparatus 10-3 generates a “payment rejection” which includes the data “TR0001” of the “transaction ID”, and transmits the “payment rejection” to the payment management apparatus 20 (step S1215-2).

Next, in a case where the “payment confirmation” is received from the terminal apparatus 10-2 within “N₂” days since the “payment request” has been sent to the terminal apparatus 10-2 in step S1213-1, the separate checks processing section 212A of the payment management apparatus 20 sends a request to the credit inquiry section 213 so that the credit inquiry section 213 sends the “credit inquiry”. Then, based on the credit card information “B”, the credit inquiry section 213 sends the “credit inquiry” to the credit card payment system 40 of the card company “B” (step S1216). When the “credit inquiry” is accepted, the separate checks processing section 212A of the payment management apparatus 20 updates the data of the “charge confirmation status” of the corresponding “separate checks target user” in the transaction information of the transaction information table 23AD to “YES”. That is, the data of the “charge confirmation status” of the “user_id_b” of the “separate checks target user ID” in the transaction corresponding to the data “TR0001” of the “transaction ID” is updated to “YES”.

On the other hand, in step S1216, in a case where “N₂” days have passed since the “payment request” has been sent to the terminal apparatus 10-2 in step S1213-1, the separate checks processing section 212A of the payment management apparatus 20 transmits a “payment disapproval notification” (e.g., a payment request rejection notice) to the terminal apparatus 10-2.

As described above, it is desired that the “credit inquiry” of the separate checks target users excluding the transaction user is performed within “N₂” units of time (e.g., minutes, hours, days, weeks, etc.) since the “payment request” is transmitted to the terminal apparatuses 10 of the separate checks target users. When “N₂” days (assuming the desired time period has been set to days) have passed since the “payment request” is transmitted, as described below, it is assumed that, at the timing when “N₂” days have passed, the transaction user pays the separate checks amount of the separate checks target user whose “credit inquiry” is not performed. Therefore, by doing this, it becomes possible to avoid the status that the “payment confirmation” is not performed within the desired time period because the separate checks target user does not accept the payment of the separate checks amount within the desired time period. In the following description, it is assumed that the separate checks processing section 212A of the payment management apparatus 20 receives the “payment confirmation” from the terminal apparatus 10-1 and the above “credit inquiry” is performed within “N₂” days since the “payment request” is transmitted to the terminal apparatus 10-2.

Next, the separate checks processing section 212A of the payment management apparatus 20 refers to the transaction information table 23AD, and updates the separate checks amount of the transaction user in a manner such that the separate checks amount of the separate checks target user (excluding the transaction user), whose data of the “charge confirmation status” is set to “NO”, is added to the separate checks amount of the transaction user (step S1217). That is, in this case, while the separate checks amount “3,000” of the separate checks target user whose “separate checks target user ID” is “user_id_c” is changed into “0”, the separate checks amount of the separate checks target user whose “separate checks target user ID” is “user_id_a” (i.e., the transaction user) is changed into “6,000”. By doing this, the separate checks amount of the separate checks target user who rejects the payment of the separate checks amount is to be paid by the transaction user. Further, the separate checks amount of the separate checks target user whose “credit inquiry” is not performed within “N₂” days since the “payment request” is transmitted is also to be paid by the transaction user.

The credit inquiry section 213 of the payment management apparatus 20 corrects the amount of the “credit inquiry”, which is performed in step S1207, of the transaction user (user “A”) (step S1218). That is, the credit inquiry section 213 of the payment management apparatus 20 transmits the “credit inquiry”, in which the “payment amount” of the “credit inquiry” in step S1207 is corrected (changed) into the “separate checks amount” (6,000 in this case) which is updated in step S1217, to the credit card payment system 40-1. When the “credit inquiry” is accepted, the separate checks processing section 212A of the payment management apparatus 20 updates the data of the “charge confirmation status” of the transaction user in the relevant transaction information in the transaction information table 23AD to “YES”. That is, the separate checks processing section 212A updates the data of the “charge confirmation status” of the user whose “separate checks target user IS” is “user_id_a” in the transaction information whose “transaction ID” is “TR0001” to “YES”.

Finally, the separate checks processing section 212A of the payment management apparatus 20 refers to the transaction information table 23AD, and sends a request to the charge confirmation section 214, so that the charge confirmation section 214 performs the “charge confirmation” relative to the “credit inquiry” of the separate checks target user whose “charge confirmation status” is set to “YES” in the relevant transaction information. Then, the charge confirmation section 214 performs the “charge confirmation” relative to the respective electronic payment systems (e.g., credit card payment systems 40) (step S1219). That is, charge confirmation section 214 performs the “charge confirmation” relative to the “credit inquiry” of the user “B” (whose user ID is “user_id_b”) in step S1216, and the “charge confirmation” relative to the “credit inquiry” of the user “A” (whose user ID is “user_id_a”) in step S1218. By doing this, the charges are confirmed of the separate checks amounts by the respective credit cards between the user “A” and user “B”. Further, in this case, the separate checks amounts to be paid by the user “A” and “B” are “JPY 6,000” and “JPY 3,000”, respectively (that is, the separate checks amount of the user “C” who rejects the payment is added to the (original) separated checks amount of the user “A”). As described above, in a case where one or more users of the separate checks target users reject the payment of the separate checks amounts or an approval period (i.e., the above “N₂” days) has passed, it is controlled in a manner such that the separate checks amount of the user who rejects the payment or when the approval period has passed is paid by the transaction user.

As describe above, in the payment management system 1 according to some example embodiments, the payment amount (e.g., price of the goods, services, etc.), purchased by the transaction user by credit card (and/or other payment method) can be paid by separate checks by a plurality of users using the respective credit cards (and/or other payment methods). Further, in this case, the users, who pay by separate checks, can use the respective their desired payment methods to pay, and the types of payment methods is not limited.

Further, in the payment management system 1 according to at least one example embodiment, in the case where, for example, the amount of the goods purchased by the transaction user by a first payment method (e.g., credit card) is to be paid by separate checks by a plurality of users, the transaction is first completed when the credit (and/or account) inquiry relative to the transaction user's payment method (e.g., credit card) is completed. Therefore, for example, it becomes possible for the shop who sold the goods to promptly perform the transaction without waiting for the completion of the credit inquires of all the separate checks target users.

Further, in the payment management system 1 according to at least one example embodiment, for example, in a case where one or more users of the separate checks target users reject the payment of the separate checks amounts or the approval period has passed, the deficit of the separate checks amounts can be paid by the transaction user.

The example embodiments as disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

What is claimed is:

1. An information processing system, comprising:
at least one information processing apparatus;
the at least one information processing apparatus including a memory having computer readable instructions stored thereon, and
at least one processor configured to execute the computer readable instructions to,
transmit a first request to a first terminal apparatus, the first request including a request for payment of a desired commercial transaction,
receive a response to the first request from the first terminal apparatus, the response including an approval of paying for the desired commercial transaction,
perform a credit inquiry on a credit card to be used for a transaction related to the desired commercial transaction
determine whether the response includes separate checks information, the separate checks information indicating payment is to be made by a plurality of users, and content of the desired commercial transaction has been changed within a desired time period since performing the credit inquiry, and
instruct payment of the commercial transaction based on the results of the determination.

2. The information processing system according to claim 1, wherein the determination includes,
determine whether the response includes the separate checks information and information indicating that new commercial transactions were generated for the plurality of users excluding the user who responded to the first request;
transmit a second request to each of the terminal apparatuses associated with the other users, the second request including requests for payment for the respective new commercial transactions;
receive second responses to the second request from the terminal apparatuses associated with the other users, including credit card information associated with the other users;
perform credit inquiries on the credit card information provided in the received second responses; and
change the content of the desired commercial transaction based on a result of the credit inquiries performed.

3. The information processing system according to claim 2, wherein the at least one processor is further configured to execute the computer readable instructions to:
identify a commercial transaction, to which payment is to be made among the newly generated commercial transactions, based on the performed credit inquiries; and
change the content of the desired commercial transaction based on the content of the identified commercial transaction.

4. The information processing system according to claim 2,
wherein the second request includes separate checks amounts which are amounts of the commercial transactions newly generated for the other users.

5. The information processing system according to claim 4,
wherein the separate checks amounts are amounts which are designated to the other users or the amount which is calculated by evenly dividing an amount of the desired commercial transaction by a number of the plurality of users.

6. The information processing system according to claim 2, wherein the at least one processor is further configured to execute the computer readable instructions to:
pay the commercial transactions generated for the users by paying electronic money corresponding to amounts of the commercial transactions to the user who responded to the first request when the other users include users who desire to pay using electronic payment.

7. The information processing system according to claim 1, wherein the at least one processor is further configured to execute the computer readable instructions to:instruct payment of the desired commercial transaction in a case where although the response to the first request includes the separate checks information, the content of the desired commercial transaction is not changed and the desired time period has passed since performing the credit inquiry.

8. An information processing method, comprising:
transmitting, using at least one processor, a first request to a first terminal apparatus, the first request including a request for payment of a desired commercial transaction;
receiving, using the at least one processor, a response to the first request from the first terminal apparatus, the response including an approval of paying for the desired commercial transaction;
performing, using the at least one processor, a credit inquiry on a credit card to be used for a transaction related to a desired commercial transaction;
determining, using the at least one processor, whether the response includes separate checks information, the separate checks information indicating payment is to be made by a plurality of users, and content of the desired commercial transaction has been changed within a desired time period since performing the credit inquiry; and
instructing payment, using the at least one processor, of the commercial transaction based on the results of the determining.

9. The method according to claim 8, wherein the determining comprises:
determining, using the at least one processor, whether the response includes the separate checks information and information indicating that new commercial transactions were generated for the plurality of users excluding the user who responded to the first request;
transmitting, using the at least one processor, a second request to each of the terminal apparatuses associated with the other users, the second request including requests for payment for the respective new commercial transactions;
receiving, using the at least one processor, second responses to the second request from the terminal apparatuses associated with the other users, including credit card information associated with the other users;
performing, using the at least one processor, credit inquiries on the credit card information provided in the received second responses; and
changing, using the at least one processor, the content of the desired commercial transaction based on a result of the credit inquiries performed.

10. The method according to claim 9, further comprising:
identifying, using the at least one processor, a commercial transaction, to which payment is to be made among the newly generated commercial transactions, based on the performed credit inquiries; and
changing, using the at least one processor, the content of the desired commercial transaction based on the content of the identified commercial transaction.

11. The method according to claim 9, wherein the second request includes separate checks amounts which are amounts of the commercial transactions newly generated for the other users.

12. The method according to claim 11, wherein the separate checks amounts are amounts which are designated to the other users or the amount which is calculated by evenly dividing an amount of the desired commercial transaction by a number of the plurality of users.

13. The method according to claim 9, further comprising:
paying, using the at least one processor, the commercial transactions generated for the users by paying electronic money corresponding to amounts of the commercial transactions to the user who responded to the first request when the other users include users who desire to pay using electronic payment.

14. The method according to claim 8, further comprising:
instructing payment, using the at least one processor, of the desired commercial transaction in a case where although the response to the first request includes the separate checks information, the content of the desired commercial transaction is not changed and the desired time period has passed since performing the credit inquiry.
